(19) United States
(12) Patent Application Publication
(10) Pub. No.: US 2011/0128580 A1
(43) Pub. Date: Jun. 2, 2011

(54) IMAGE FORMING APPARATUS (PRINTING TIME SETTING FUNCTION)

(75) Inventor: Yuji Kazama, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/956,260

(22) Filed: Nov. 30, 2010

Related U.S. Application Data
(60) Provisional application No. 61/265,820, filed on Dec. 2, 2009.
(60) Provisional application No. 61/288,652, filed on Dec. 21, 2009.

(51) Int. Cl. G06F 15/00

(52) U.S. Cl. 358/1.15

(57) ABSTRACT

According to one embodiment, an image forming apparatus including, a data acquiring unit configured to receive data, an image forming unit configured to visualize the data input to the data acquiring unit and output the data onto a sheet medium, and a managing unit configured to store a condition for visualizing the data input to the data acquiring unit and permit the visualization of the data by the image forming unit according to the visualizing condition.

### CROSS-REFERENCE TO RELATED APPLICATIONS

This application is based upon and claims the benefit of priority from: US Provisional Applications No. 61/265,820 filed on Dec. 2 2009 and No. 61/288,652 filed on Dec. 21 2009, the entire contents of each of which are incorporated herein reference.

### FIELD

Embodiments described herein relates generally to an image forming apparatus.

### BACKGROUND

An image forming apparatus called MFP (Multi-Functional Peripheral) visualizes input data and outputs the visualized input data onto a sheet medium. One of the input data includes a facsimile data.

The facsimile data comes in without being subjected to temporal limitation. On the other hand, incoming data is printed out in incoming order. Therefore, an arbitrary user is allowed to check a printout of even data addressed to a specific user (client).

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of an MFP (Multi-Functional Peripheral), according to an embodiment;

FIG. 2 is an exemplary diagram showing an example of a user management block of the MFP, according to an embodiment;

FIG. 3 is an exemplary diagram showing an example of a transmission destination address book of the MFP, according to an embodiment;

FIG. 4 is an exemplary diagram showing an example of a reception destination address book of the MFP, according to an embodiment;

FIG. 5 is an exemplary diagram showing an example of data of the reception destination address book, according to an embodiment;

FIG. 6A is an exemplary diagram showing an example of a user name input screen of the MFP, according to an embodiment;

FIG. 6B is an exemplary diagram showing an example of a character string input screen of the MFP, according to an embodiment;

FIG. 6C is an exemplary diagram showing an example of a password input screen of the MFP, according to an embodiment;

FIG. 6D is an exemplary diagram showing an example of a character string input screen of the MFP, according to an embodiment; and

FIG. 7 is an exemplary diagram showing an example of a printout timing of the MFP, according to an embodiment.

### DETAILED DESCRIPTION

In general, according to an embodiment, an image forming apparatus including: a data acquiring unit configured to receive data; an image forming unit configured to visualize the data input to the data acquiring unit and output the data onto a sheet medium; and a managing unit configured to store a condition for visualizing the data input to the data acquiring unit and permit the visualization of the data by the image forming unit according to the visualizing condition.

Embodiments will now be described hereinafter in detail with reference to the accompanying drawings.

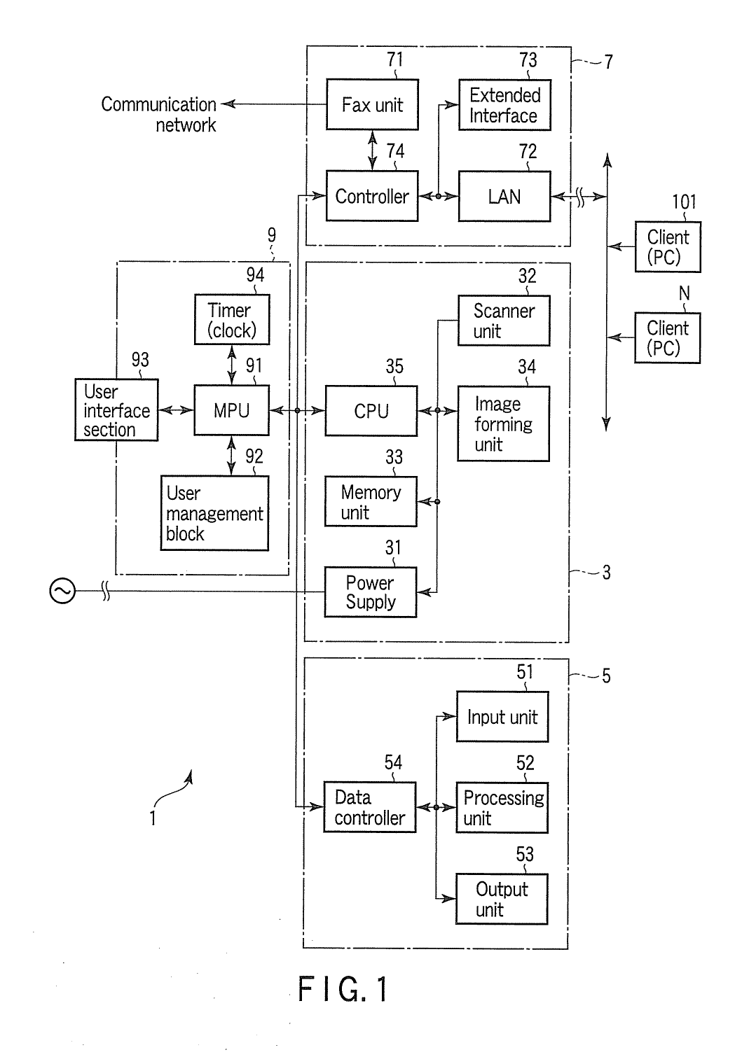

FIG. 1 shows an example of an outline of an MFP (Multi-Functional Peripheral; an electronic apparatus).

An MFP 1 includes at least an image forming unit 3, a data managing unit 5, a communication control unit 7, and a system control unit 9.

The image forming unit 3 visualizes an image or a character on the basis of data of an arbitrary format and outputs the visualized image or character onto a sheet medium. The data managing unit 5 receives the data and, manages the data for execution of a job such as print output or storage. The communication control unit 7 manages transmission and reception of the data between the MFP 1 and a communication line (a network). The system control unit 9 controls the image forming unit 3, the data managing unit 5, and the communication control unit 7, i.e., the operation of the MFP 1.

The image forming unit 3 includes at least a power supply unit 31, a scanner unit 32, a memory unit 33, an image forming unit 34, and a process control unit (a process controller) 35 configured to control the units of the image forming unit 3.

The power supply unit 31 is connected to a commercial power supply and generates a secondary side voltage used for the operation of the MFP 1 (from a primary side voltage). It goes without saying that, concerning the primary side voltage, an input allowable current is managed.

When a format of information such as an image, a character, a shape, or a color visualized and output onto a sheet medium by the image forming unit 34 is a non-data format, the scanner unit 32 outputs the information as image data. The scanner unit 32 radiates light on a sheet-like document or a solid body including information, acquires an electric signal corresponding to the intensity of the light reflected on the image (image light), and converts the electric signal into image data.

The memory unit 33 stores the image data obtained by the scanner unit 32 or image data input from the outside. The memory unit 33 stores a computer program, an application (software), an address table (address book data) explained later, or the like.

The image forming unit 34 visualizes the image data and outputs the visualized image data onto the sheet medium. As a method of visualization, an electrostatic transfer system using toner or a direct recording system using ink is often used. A hot stamp or the like for output of special colors (gold and silver) may be used together with the electrostatic transfer system or the direct recording system.

The image forming unit 3 stores an image output by the image forming unit 34 and includes a feeding mechanism for a sheet medium fed to the image forming unit 34.

The data managing unit 5 includes at least a data input unit 51 configured to receive data, a data processing unit 52 configured to process, for execution of a job such as print output and storage, the data received by the data input unit 51, a data output unit 53 configured to output, in a format specified by the job, the data processed by the data processing unit 52, and a data control unit (a data controller) 54 configured to control exchange of the data between the data processing unit 52 and the data output unit 53.

The communication control unit 7 includes at least a facsimile (communication) unit 71 connected to a public communication line and configured to receive or transmit facsimile data, a LAN (communication) unit 72 connected to an external network, for example, a LAN (Local Area Network) and configured to receive data from or transmit data to the network, an extended interface unit 73 corresponding to, for example, the USB (Universal Serial Bus) standard and configured to receive data from or transmit data to a partner connected thereto, and a communication control unit (a communication controller) 74 configured to control communication, data input and output, parallel processing, and the like with the partner by each of the facsimile (communication) unit 71, the LAN (communication) unit 72, and the extended interface unit 73.

The system control unit 9 includes at least a main control block (a MPU) 91 and a user usage management block 92. The MPU 91 is connected to the process controller 35, the data controller 54, and the communication controller 74 of the units explained above and controls the units. The user usage management block 92 manages permission of use of the MFP 1, for example, permission of usable functions for each user, authority to, for example, a change of setting, time setting for printout of incoming facsimile data explained later, and the like.

The MPU 91 is connected to a user interface section 93, receives an instruction input for the start and the stop of the operations of the units, condition setting, or the like from an input panel area included in the user interface section 93, and outputs a control signal for controlling the operations of the units in response to the instruction input. The input panel area of the user interface section 93 is desirably, for example, a touch panel type in which a display area is integrally formed. The user interface section 93 includes a function as an authentication unit for authentication of a user such as a face recognizing unit configured to recognize characteristics of the face of the user, a biometric authentication unit configured to authenticate the user using biological characteristics of a palm or a finger of the user, or a card reader configured to use, when a medium such as an ID card is used, identification information recorded in the card. Therefore, the authentication unit of the user interface section 93 is easily detected a medium for authentication, when in a user authentication of the instruction input. For example, a card reader to read the identification information (the authentication medium) is positioned an outer housing of the scanner unit 22, when the authentication medium is the ID card. The authentication medium for allowing (for personal authentication) is communication through an identification medium (ID card) for personal authentication, for example. An antenna and an authentication processing circuit to input the identification information (the authentication detect) to the user interface section 93 are positioned an outer housing of the scanner unit 22, when the authentication medium is communication through type.

The MPU 91 is connected to a timer unit 94. The timer unit 94 stores, on the basis of a clock generated by a clock generating unit (CLK) 94-1, year (yyyy), month (mm), date (dd), hour (hh), and minute (mm). The clock generating unit (CLK) may be provided in the system control unit 9 for the operation of the MPU 91. For counting of time or storage of time data by the timer unit 94, for example, a frequency of a commercial power supply input to the power supply unit 31 of the image forming unit 3 may be used or time data (a time tone service signal) included in a broadcast signal (of a space wave) may be directly received.

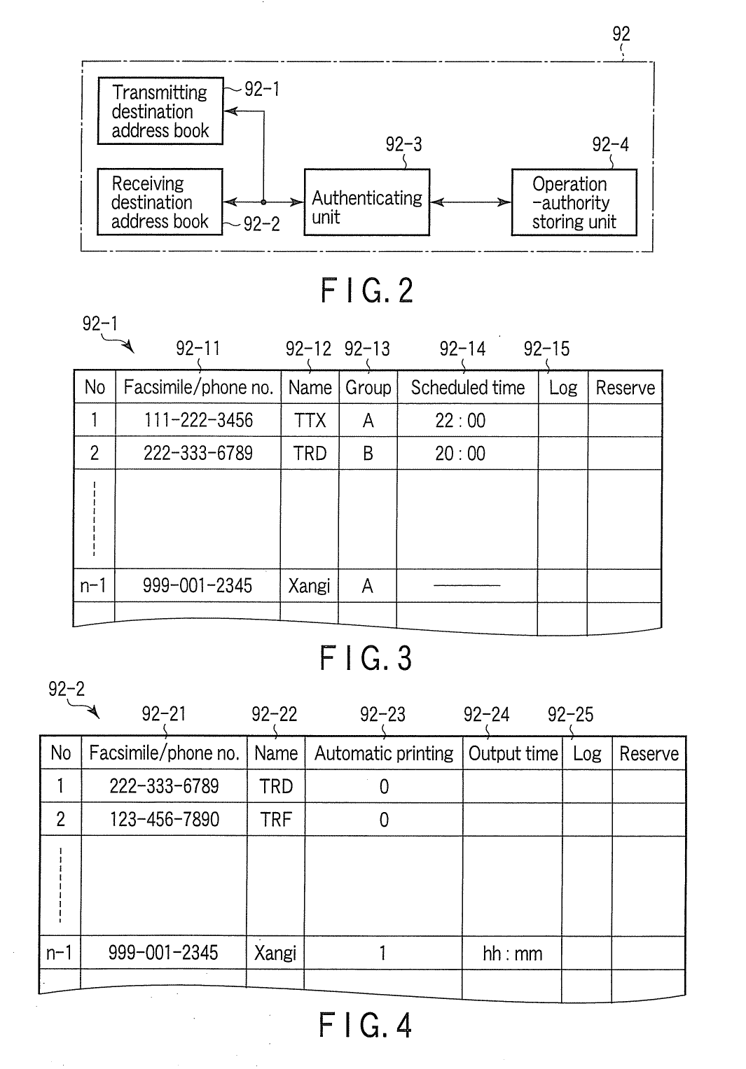

FIG. 2 shows an example of elements of the user management block.

The user management block 92 includes at least a transmission destination address book 92-1 configured to store facsimile numbers, partner names, and the like of transmission partners usable in facsimile transmission from the facsimile unit 71, a reception destination address book 92-2 configured to store facsimile numbers, partner names, and the like of reception partners usable in facsimile reception by the facsimile unit 71, and an authenticating unit 92-3 configured to receive authentication for specifying an administrator in setting of rewriting, new registration, deletion, and the like of the contents (the facsimile numbers and the names) stored by the address books. The transmission destination address book 92-1 and the reception destination address book 92-2 may be provided in the memory unit 33 included in the image forming unit 3 and may be formed in a format for referring to the memory unit 33 according to an access from the user management block 92.

The user management block 92 further includes an operation-authority storing unit 92-4 configured to store usable functions of the MFP 1 for each user. Elements to which operation authority is applied include, for example, color image output that is expensive compared for black image output, facsimile transmission that incurs communication expenses, and upper limits of the numbers of output sheets per one time, one day, and the same user related to necessity of supply of sheet media.

As indicated by an example shown in FIG. 3, the transmission destination address book 92-1 includes at least a partner facsimile number space 92-11, a partner name space 92-12, a group setting space 92-13 in which a group is set when a group mode for collecting an arbitrary number of partners is used during transmission, a transmission time space 92-14 in which transmission scheduled time in using time setting (scheduled transmission) during transmission is stored, and a log area 92-15 in which history information such as occurrence of a transmission error (inability to transmit) during transmission is stored.

As indicated by an example shown in FIG. 4, the reception destination address book 92-2 includes at least a reception partner facsimile number space 92-21, a partner name space 92-22, a designated time output (automatic printing) mode space 92-23 in which setting of a designated time output mode for printing out (outputting) received data at scheduled time without immediately printing out the received data is stored, an output time space 92-24 in which time (hour) when the received data should be output is stored when designated time output is set, and an access log area 92-25 in which an access record of an administrator who manages setting of the designated time output (automatic printing) mode is stored.

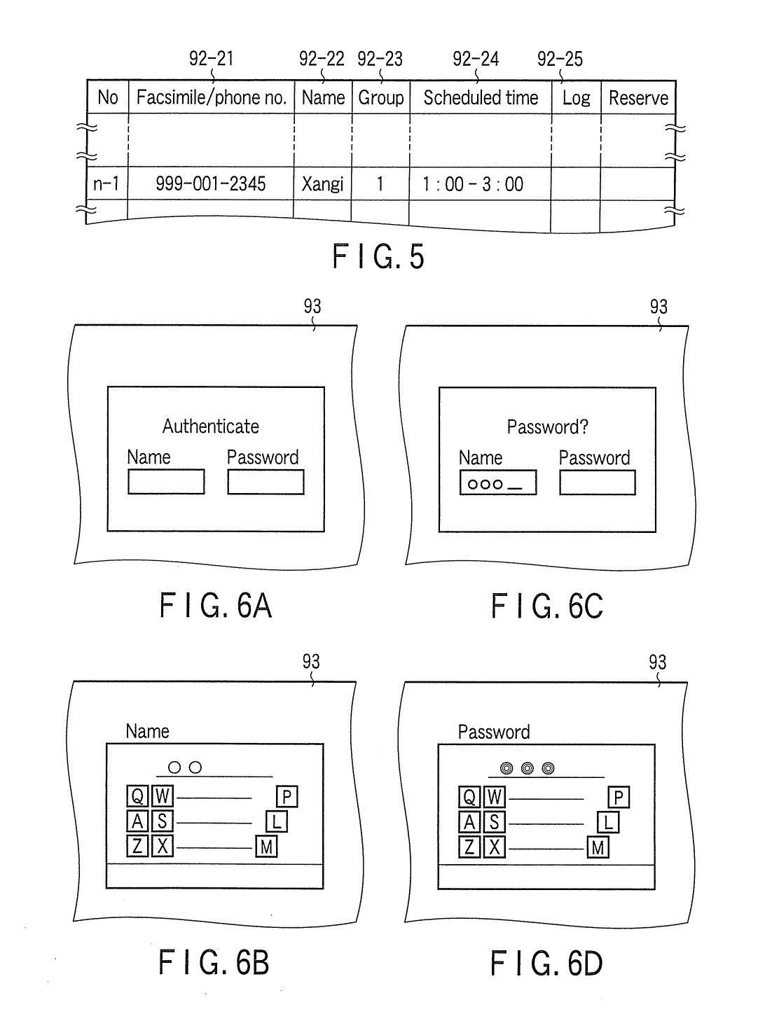

FIG. 5 shows an example of an address book that enables, when facsimile is transmitted from a reception partner registered in the reception destination address book, printout (incoming automatic printing) by the designated time output (the automatic printing) only within time in which a person as a destination of the incoming facsimile is present.

In FIG. 5, it is seen that, concerning reception from an n-1th reception partner, the designated time output (the automatic printing) is set and designated time of the designated time output is 1:00 pm to 5:00 pm.

FIG. 6A shows an example of an authentication screen (display) for authenticating that a user is an administrator having a right (authority) of change when the user changes the contents of the reception destination address book shown in FIGS. 4 and 5.

In FIG. 6A, display 601 is an example of an input screen displayed in the input panel area included in the user interface section 93. For example, when a user selects user name display 611, a character input screen 631 shown in FIG. 6B is displayed. Therefore, the user only has to input a predetermined user name. When the input user name is received, the input screen shifts to a password input screen shown in FIG. 6C. When the user selects password display 621 on the password input screen, a character input screen shown in FIG. 6D is displayed. Therefore, the user only has to input a predetermined password. The display example is only an example. The character input screen 631, the user name display 611, and the password display 621 may be displayed on the same screen.

FIGS. 6A to 6D are an example of (direct) input by the user interface section 93. When a user who is about to change the contents of the address book is, for example, an arbitrary client (a PC 101 connected to the LAN unit 72 in FIG. 1) in a network including the MFP 1, a display format and an input screen peculiar to the apparatus (the PC 101) is prepared.

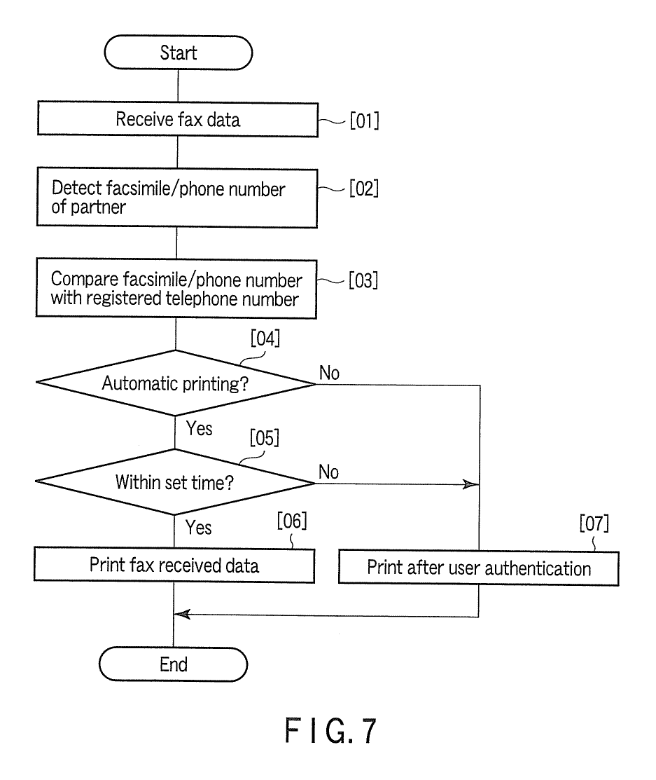

FIG. 7 shows a flow of printout (automatic printing) of facsimile data received by the MFP.

In facsimile data reception [01], the MFP 1 receives facsimile data from an arbitrary partner.

At this time, the MFP 1 acquires (detects) a facsimile number of the partner [02] and determines whether the partner is a partner registered in an address book [03].

If the facsimile data is received from the facsimile number not registered in the address book [03-NO], the MFP 1 directly prints out the facsimile data. However, the MFP 1 can be set to store the received data within a range of a storage capacity of a memory and print only data desired by a user. Specifically, a data management application or program for permitting printout only for data requested by the user is prepared and only data determined by the user to be printed is printed. This makes it possible to reduce cost of sheet media and a visualizing agent.

If the acquired facsimile number of the partner is registered in the address book [03-YES], the MFP 1 detects whether the partner (the facsimile number) is managed as a target of the automatic printing (the designated time output) [04].

If a transmission source of the received facsimile data is managed as a target of the automatic printing (the designated time output) [04-YES], the MFP 1 checks an automatic printing hour (designated time) recorded in the address book [05].

If the present time is within the checked automatic printing hour (designated time) recorded in the address book [05-YES], the MFP 1 prints the received facsimile data [06].

If the present time is outside the checked automatic printing hour (designated time) recorded in the address book [05-NO], the MFP 1 can print the received facsimile data through user authentication [07]. The MFP 1 can also print, through user authentication, received data that is not a target of the automatic printing (the designated time output) [04-NO].

By adopting such a configuration, the received data is automatically printed only within time in which the automatic printing time is set, i.e., under a condition (within time) in which a user designated as a reception destination can immediately check (acquire, collect, and carry back) printed facsimile data. Therefore, a factor causing careless printing of facsimile data coming in at unintended timing, for example, during absence of the user and allowing another person to view the content of the facsimile data is eliminated. Also, an accident that the printout of the facsimile data is carried off (lost) by another person by mistake is prevented.

As a result, security for facsimile received data (document) is improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a data acquiring unit configured to receive data;
an image forming unit configured to visualize the data input to the data acquiring unit and output the data onto a sheet medium; and
a managing unit configured to store a condition for visualizing the data input to the data acquiring unit and permit the visualization of the data by the image forming unit according to the visualizing condition.

2. The apparatus of claim 1, wherein the data acquired by the data acquiring unit is input to the data acquiring unit through a communication network.

3. The apparatus of claim 2, wherein the managing unit permits, according to information concerning a data supply source, the visualization of the data input to the data acquiring unit.

4. The apparatus of claim 2, further comprising an information table configured to store information concerning a data supply source, the information table is referred by managing unit.

5. The apparatus of claim 4, wherein the managing unit permits, according to the information concerning the data supply source stored by the information table, the visualization of the data input to the data acquiring unit.

6. The apparatus of claim 5, wherein the managing unit permits the visualization only in a visualization permission hour stored by the information table.

7. The apparatus of claim 4, wherein the managing unit requests, according to the information concerning the data supply source stored by the information table, user authentication for visualizing the data input to the data acquiring unit.

8. A method of data management comprising:
acquiring data; and
referring to a condition for visualizing the acquired data and permitting visualization of the data by an image forming unit according to the visualizing condition.

9. The method of claim 8, wherein the data is input to a data acquiring unit through a communication network.

10. The method of claim 9, wherein the permission of the visualization of the data is determined according to information concerning a data supply source.

11. The method of claim 9, further comprising an information table storing the visualizing condition.

12. The method of claim 11, wherein the permission of the visualization of the data is determined according to the information concerning the data supply source stored by the information table.

13. The method of claim 12, wherein the permission of the visualization of the data is obtained only within a visualization permission hour stored by the information table.

14. The method of claim 9, wherein user authentication for visualizing the data input to the data acquiring unit is requested according to the information concerning the data supply source stored by an information table.

15. A data managing apparatus comprising:
a data acquiring unit configured to receive data; and
a managing unit configured to store a condition for visualizing the data input to the data acquiring unit and permit the visualization of the data by an image forming unit according to the visualizing condition.

16. The apparatus of claim 15, wherein the data acquired by the data acquiring unit is input to the data acquiring unit through a communication network.

17. The apparatus of claim 16, wherein the managing unit permits, according to information concerning a data supply source, the visualization of the data input to the data acquiring unit.

18. The apparatus of claim 17, further comprising an information table configured to store information concerning a data supply source, the information table is referred by managing unit.

19. The apparatus of claim 18, wherein the managing unit permits, according to the information concerning the data supply source stored by the information table, the visualization of the data input to the data acquiring unit.

20. The apparatus of claim 19, wherein the managing unit permits the visualization only in a visualization permission hour stored by the information table.
